(19) United States
(12) Patent Application Publication
(10) Pub. No.: US 2024/0185835 A1
(43) Pub. Date: Jun. 6, 2024

(54) SYSTEM FOR ASSISTING THE BLIND IN FINANCIAL MANAGEMENT

(71) Applicant: Hillming Company Limited, Kowloon (HK)

(72) Inventor: Hillming LI, Kowloon (HK)

(21) Appl. No.: 18/076,144

(22) Filed: Dec. 6, 2022

(51) Int. Cl. G10L 13/08; G06Q 20/36; G06V 10/764; G06V 40/70

(52) U.S. Cl. CPC G10L 13/08; G06Q 20/3674; G06V 10/764; G06V 40/70; G06V 2201/10

(57) ABSTRACT

A system for assisting the blind in financial management is used for mobile phones, computers, and other communication terminals to operate without relying on eyesight, and dealing with related commodity transactions, online shopping, taxi service, food delivery, takeaway order, fee payment, membership services, purchasing services, sending red envelopes, buying and selling services, leasing services, payment, collection, transfer, refund, currency exchange, account inquiry, e-wallet management, stock securities investment, foreign exchange fund trading, futures real estate and/or other related finance and other mobile banking services.

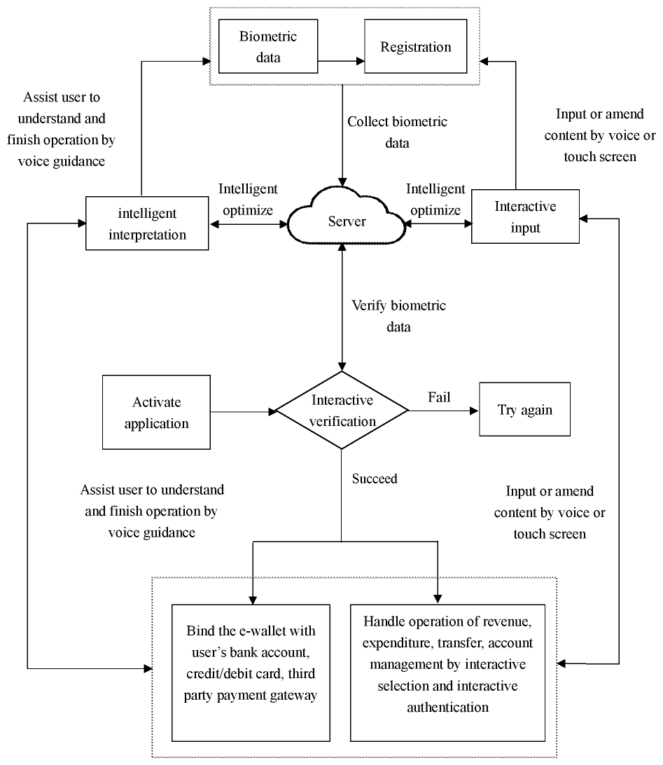

### FIELD OF THE INVENTION

The present invention relates to a method and system for electronic banking, consumer payment, e-commerce, financial investment and other businesses for visually impaired and blind user.

### BACKGROUND OF THE INVENTION

According to information from the World Health Organization, there are about 38.6 million blind people and 285 million people with visual impairment worldwide. And there are about 170,000 blind peoples in Hong Kong and over 17 million in Mainland China. Helping the groups to solve financial payment problem can not only enable them to overcome the obstacle of visual impairment, but also release huge consumption power and has great commercial value.

For visually impaired and blind people who cannot independently handle online consumption, electronic financial management and other difficulties, the present invention provides a solution and system that integrates multiple technologies, by setting AI optimization, biometric verification, interactive input and intelligent Interpretation to enable user conducting consumption, investment and financial management without relying on vision, and solve the problem that blind people cannot handle online financial operations alone in the existing technology.

### SUMMARY OF THE INVENTION

The facility of the present invention is to provide a method and system for conducting electronic banking, consume payment, e-commerce, financial investment and other business for visually impaired and blind user.

The invention achieves by:
the system for assisting the blind in financial management, comprising
an intelligent interpretation module for converting information into speech, which includes at least a pre-defined data database and a speech prompt device;
an interactive verification module, which connects to a biometric data source of the user, and collects the real time biometric to compare with the biometric data for completing the verification and issuing the verification result;
an interactive input module, which includes a voice and/or a handwriting input for the user outputting the operation commands or inputting message;
a payment gateway, which holds the blind user's e-wallet, the e-wallet binds with the band account and/or credit card and/or payment account;
an intelligent assistant module, which embeds with an intelligent processing program including a multiple modality algorithm; the intelligent assistant connects with a video capture device and/or an audio capture device, processes and analyses the information of the capture device, and then obtains the corresponding information and transmits to an intelligent interpretation module to provide speech prompt to the blind user; the blind user controls the interactive input module to operate according to the speech prompt and be authenticated through the interactive verification module for the payment module completing the financial management operation.

Further, the interactive verification module comprising a face recognition module and/or an voice recognition module and/or a fingerprint recognition module and/or a palmprint recognition module and/or a security token.

Further, the e-wallet binds with the user's email and/or mobile phone number.

Further, the multiple modality algorithm comprising computer vision processing of images and text and natural language processing;
the computer vison processing includes following steps:
a. obtains real time visual signals through video capture device, including images and videos;
b. pre-processes the visual signals;
c. detects objects of visual signals;
d. tracks the objects;
e. processes images and classifies objects;
f. obtains metadata of the objects;
the natural language processing includes: after processing by the computer vision, the metadata is input and processed which is divided into structured text analysis processing and semantic understanding processing; the verbal command inputs for voice recognition processing and transmits to a natural language understanding processing; an AI center, which is used to input and synthesise all the above processing information to form tasks, output the information of the task to intact with the user, process natural language processing, and finally send the guide voice to the user by the intelligent interpretation module.

Compared with prior art, the beneficial effects of the present invention are: the user can use mobile phones, computers, and other communication terminals to operate without relying on eyesight, and deal with related commodity transactions, online shopping, taxi service, food delivery, takeaway order, fee payment, membership services, purchasing services, sending red envelopes, buying and selling services, leasing services, payment, collection, transfer, refund, currency exchange, account inquiry, e-wallet management, stock securities investment, foreign exchange fund trading, futures real estate and/or other related finance and other mobile banking services.

### BRIEF DESCRIPTION OF THE DRAWINGS

For further illustrating the technical solutions in the embodiments of the present invention, the drawings are provided below to describe the embodiments in detail.

The FIGURE is a schematic diagram of the system of the present invention.

### DESCRIPTION OF THE EMBODIMENTS

With reference to the FIGURE, an application (APP) is developed for users, which includes intelligent interpretation, biometric verification, interactive input and AI optimisation modules.

When a user registers, the application activates microphone, speaker, camera, touch screen and other built-in or attached communication devices of the user's terminal, to collect the user's biometric samples and upload them to the AI server for data filtering, identification and classification for identity verification purposes.

After successful registration, the intelligent interpretation module in the app will guide the user to bind their bank account, credit card, third party payment gateway and other accounts to the e-wallet in the app for financial management.

When the user make payments, transfer or receive payments, the intelligent interpretation module speaks out the specific content, guides the user to modify the content, fill in the address, enter the password, make choices and other interactive actions through voice or touch screen input, and finally checks with the biometric features of the server to verify the user's identity and completes the operation process.

The application involves computer programming languages, such as Python, Swift, JavaScript, C#, C, Ruby, PHP, Haskell, Java, C++. The user terminal can be a mobile phone, computer, consumer electronic device or other communication device. The present invention does not need to change the hardware of the existing communication equipment, and only uses programming command to call the built-in or attached device of the user terminal. The server includes a databases, an artificial intelligence engine, machine learning and convolutional neural network applications. The transportation includes wired and wireless technologies, such as Internet, Wifi, Bluetooth, NFC, RFID, API etc. communication technologies.

The application collects the user's biometrics and other personal data with security measures (encrypts the personal data when necessary) to protect the user's data from being misused or from unauthorized access, modification or destruction.

The whole system consists of the following processing modules.
1) the intelligent interpretation module: explains the information detected by the application to the user stored in the pre-defined data database, so that the congenitally blind without any visual experience can have a clear impression of the received information and understand the original intention, concept or/and requirements of the information. And at the same time describes the relevant conditions and implementation steps to meet the requirements. If the user decides to respond to the information request, a voice prompt is activated to assist the user to operate on the implementation step through interactive input module. Users can turn on or off the smart interpretation module independently.
2) the interactive verification module: is integrated with many existing biometric authentication methods, but not limited to face scanning, voiceprint, fingerprint, palmprint, security token, etc. The intelligent interpretation module explains the requirements and steps of the authentication procedure to the user, and at the same time guides the user to meet these requirements and finish one or more biometric sampling operations. The collected biometrics are uploaded to the server for identity verification purposes.
3) the interactive input module: is integrated with many input methods, includes but not limited to Voice, touch screen, handwriting and other existing input methods. The intelligent interpretation module explains the operation and usage of the input method to the user, and returns the input result to the user for checking or modification. The intelligent optimization module continuously optimizes by learning the user's habits, providing personalized input convenience.
4) the interactive binding module: the intelligent interpretation module explains to users why and how to bind email addresses, mobile phone numbers, bank accounts, credit/debit cards, third-party payment accounts to the e-wallet of the application, and reports the reward account whether it is successfully bonded.
5) the payment module: the intelligent interpretation module explains to users why and how to carry out the operation of receiving and paying money, guides the user to choose the deposit account when receiving money, and guides the user to choose the appropriate payment method when paying.
6) the intelligent assistant module: provides intelligent optimization options by learning the user's operating habits and behavior patterns; blind people who are born without the guidance of vision, and do not have the ability of linear mapping for the cognition of the world, so it is not suitable to use logical digital models to predict their behavior. Instead, learn useful information from the accumulated data of its input and output, use parallel computing and situation analysis to simulate and predict its behavior; establish a suitable neural network model and corresponding learning algorithm, optimize the operation process of visually impaired users, to provide a friendly and convenient personalized experience. The present invention does not require special hardware, and mainly focuses on the optimized application of artificial intelligence algorithms.

The word segmentation algorithm optimized for Natural Language Processing (NLP) can enhance the translation accuracy of Chinese meanings. The word segmentation algorithm can use forward maximum matching, reverse maximum matching, minimum word segmentation results, and path selection after full segmentation, etc. to integrate the pre-defined dictionary database, correct continuous error, and provide correct translation of words. But this is still not enough for the visually impaired, because they cannot observe pictures or objects for comparison, and may not be able to accurately understand the content by only words. In order to solve these problems, it is necessary to add a convolutional neural network (Convolutional Neural Network, CNN) image recognition function to help visually impaired users understand accurate message content. In order to integrate various information such as text, images, and audio, the present invention uses a multimodal learning algorithm to customize a personal Smart FinTech Assistant for visually impaired users. This assistant can communicate with visually impaired users as smoothly as a real human assistant, and is used to track their operations in real time, estimate the intentions of visually impaired users, and provide timely voice guidance to help them to complete their daily financial activities. The algorithm involves multiple modality processing such as image, voice, text, touch, and biometrics, and needs to combine the content of the current scene and dialogue context to understand the real needs of the visually impaired and provide smooth and timely guidance.

This module can integrate dynamic input signals of multiple modalities, and dig out meaningful semantic information from them to infer the real needs of the visually impaired. In order to meet this challenge, it is necessary to establish a multi-modal understanding model based on deep learning, and use a multi-layer transformer structure to capture and learn performance of dynamic multi-modal signals, so as to provide intelligent optimization and interactive guidance for financial planning for blind users.

1. A system for assisting the blind in financial management, comprising an intelligent interpretation module for converting information into speech, which includes at least a pre-defined data database and a speech prompt device;
an interactive verification module, which connects to a biometric data source of the user, and collects the real time biometric to compare with the biometric data for completing the verification and issuing the verification result;
an interactive input module, which includes a voice and/or a handwriting input for the user outputting the operation commands or inputting message;
a payment gateway, which holds the blind user's e-wallet, the e-wallet binds with the band account and/or credit card and/or payment account;
an intelligent assistant module, which embeds with an intelligent processing program including a multiple modality algorithm; the intelligent assistant connects with a video capture device and/or an audio capture device, processes and analyses the information of the capture device, and then obtains the corresponding information and transmits to an intelligent interpretation module to provide speech prompt to the blind user; the blind user controls the interactive input module to operate according to the speech prompt and be authenticated through the interactive verification module for the payment module completing the financial management operation.

2. The system for assisting the blind in financial management of claim 1, wherein the interactive verification module comprising a face recognition module and/or a voice recognition module and/or a fingerprint recognition module and/or a palmprint recognition module and/or a security token.

3. The system for assisting the blind in financial management of claim 1, wherein the e-wallet binds with the user's email and/or mobile phone number.

4. The system for assisting the blind in financial management of claim 1, wherein the multiple modality algorithm comprising computer vision processing of images and text and natural language processing;
the computer vison processing includes following steps:
a. obtains real time visual signals through video capture device, including images and videos;
b. pre-processes the visual signals;
c. detects objects of visual signals;
d. tracks the objects;
e. processes images and classifies objects;
f. obtains metadata of the objects;
the natural language processing includes: after processing by the computer vision, the metadata is input and processed which is divided into structured text analysis processing and semantic understanding processing; the verbal command inputs for voice recognition processing and transmits to a natural language understanding processing; an AI center, which is used to input and synthesise all the above processing information to form tasks, output the information of the task to intact with the user, process natural language processing, and finally send the guide voice to the user by the intelligent interpretation module.
